(19) United States
(12) Patent Application Publication
(10) Pub. No.: US 2025/0075066 A1
(43) Pub. Date: Mar. 6, 2025

(54) (METH)ACRYLIC COMPOSITION, COMPOSITE MATERIAL OBTAINED FROM SUCH A COMPOSITION, METHOD FOR PRODUCING SAID COMPOSITION AND USES THEREOF

(71) Applicant: Arkema France, Colombes (FR)

(72) Inventors: Jean-Marc BOUTILLIER, LACQ (FR); Gilles FRANCOIS, PIERRE-BENITE Cedex (FR); Matthieu BEHR, SAINT AVOLD Cedex (FR)

(73) Assignee: Arkema France, Colombes (FR)

(21) Appl. No.: 18/722,318

(22) PCT Filed: Dec. 22, 2022
(86) PCT No.: PCT/EP2022/087579

§ 371 Date: Jun. 20, 2024

(30) Foreign Application Priority Data
Dec. 23, 2021 (FR) 2114363

(51) Int. Cl. C08L 33/06; C08J 5/24

(52) U.S. Cl. CPC C08L 33/062; C08J 5/249; C08J 2333/10; C08J 2433/12; C08J 2453/00; C08L 2205/025; C08L 2205/03

(57) ABSTRACT

Embodiments relate to a (meth)acrylic composition and also to a composite material obtained by polymerization of such a (meth)acrylic composition. Embodiments may relate to a (meth)acrylic composition comprising also a block copolymer, preferably a (meth)acrylic block copolymer and also to a composite material obtained by polymerization of such a (meth)acrylic composition comprising a block copolymer, preferably a (meth)acrylic block copolymer. Embodiments may relate to a (meth)acrylic composition comprising also a (meth)acrylic block copolymer and a mineral filler as well to a composite material obtained by polymerization of such a (meth)acrylic composition comprising a (meth)acrylic block copolymer and a mineral filler. Embodiments may relate to a manufacturing process of a (meth)acrylic composition comprising a (meth)acrylic block copolymer and a mineral filler, manufacturing process of composite material obtained by polymerization of such a (meth)acrylic composition and also to the uses of such a (meth)acrylic composition and obtained composite material.

### FIELD OF THE INVENTION

The present invention relates to a (meth)acrylic composition and also to a composite material obtained by polymerization of such a (meth)acrylic composition.

In particular the present invention relates to a (meth)acrylic composition comprising also a block copolymer, preferably a (meth)acrylic block copolymer and also to a composite material obtained by polymerization of such a (meth)acrylic composition comprising a block copolymer, preferably a (meth)acrylic block copolymer.

More particularly the present invention relates to a (meth)acrylic composition comprising also a (meth)acrylic block copolymer and a mineral filler as well to a composite material obtained by polymerization of such a (meth)acrylic composition comprising a (meth)acrylic block copolymer and a mineral filler.

The invention also relates to a manufacturing process of a (meth)acrylic composition comprising a (meth)acrylic block copolymer and a mineral filler, manufacturing process of composite material obtained by polymerization of such a (meth)acrylic composition and also to the uses of such a (meth)acrylic composition and obtained composite material.

### Technical Problem

A composite material is a macroscopic combination of two or more non miscible materials. The composite material constitutes at least of a matrix material that forms a continuous phase for the cohesion of the structure and a reinforcing material with various architectures for the mechanical properties.

The aim in using composite materials is to achieve a performance from the composite material that is not available from its separate constituents if used alone. Consequently, composite materials are widely used in several industrial sectors as for example building, automotive, aerospace, transport, leisure, electronics, and sport notably due to their better mechanical performance (higher tensile strength, higher tensile modulus, higher fracture toughness) in comparison with homogenous materials and their low density.

The most important class in view of volume in commercial industrial scale, are composites with organic matrices, where the matrix material is a generally polymer. The principal matrix or continuous phase of a polymeric composite material is either a thermoplastic polymer or a thermosetting polymer.

One way for preparing a polymeric composite material based on thermoplastic polymers is by using a liquid polymer composition comprising a monomer, commonly known as a “syrup”. Such syrup is used for blending with a mineral filler or impregnating the reinforcing material, for example or a fibrous substrate.

The polymerization of the liquid polymer composition charged with mineral filler usually takes place in a mold.

There is a need of a polymeric composition that provides a (meth)acrylic composition comprising a monomer that can be easily blended with mineral fillers or charges.

There is also a need to control and regulate the heat generated during the polymerization of a (meth)acrylic composition comprising a monomer. By control or regulation of the heat is meant to reduce the heat generated during the exothermic polymerization reaction, for avoiding too high temperatures in the mold, for faster cooling and quicker demolding, yielding to a faster process.

There is also a need to reduce the gloss of polymeric composites comprising mineral filler, in order to have the matt surface aspect of natural stones.

Another aim of the present invention is to propose a process for manufacturing such a composite material, this process being easy to perform and making it possible to obtain the material in a limited number of steps with the equipment and tools of the industrial facilities currently used for the manufacture of composite materials.

### [BACKGROUND OF THE INVENTION] PRIOR ART

(Meth)acrylic compositions and composite materials based on (meth)acrylic compositions or resin also with mineral fillers have been described in a certain number of documents.

The document WO 2013/056845 relates to a composite material comprising a thermoplastic (meth)acrylic matrix and a reinforcing material formed by a fibrous material which may have various shapes and sizes and may be of natural or synthetic origin. The thermoplastic (meth)acrylic matrix may notably be obtained from a viscous liquid composition, referred to as a “liquid (meth)acrylic syrup”, which comprises (meth)acrylic monomers, or mixtures of (meth)acrylic monomers, and oligomers or polymers dissolved in these monomers.

The document US2008/0132607 discloses a molded plastic body and method for producing the same. Molded plastic body is produced from a cured reaction mixture. The reaction mixture in the uncured state is castable and comprises an inorganic particulate filler with a proportion of 50 to 90 percent by weight relative to the reaction mixture, a crosslinking agent, and a binder solution with a proportion from 10 to 50 percent by weight relative to the reaction mixture. The binder solution is having a monomer and a polymer dissolved therein.

The document WO2014/105936 relates to an advanced solid surface acrylic and method. The document describes a composition for making a cast, thermoformable sheet or slab. Said composition is comprising: a.) 25-100 percent of a syrup, comprising: 0-50 wt % or 35-99 wt % of prepolymerized monomer; 50-100 wt % or 35-99 wt % of at least one monomer; 0-20 wt % of at least one crosslinking agent; and 0-5 wt % of at least one chain transfer agent; and b.) solid particulates, comprising: 0-70 wt % of aluminium trihydrate; and 0-5 wt % of at least one dispersant.

The document EP2791075A1 discloses a synthetic marble with high hardness and a method of manufacturing the synthetic marble. The raw materials for the synthetic marble consists of 200 to 500 parts by weight of an inorganic filler, 0.2 to 5 parts by weight of a cross linking agent, and 0.2 to 3 parts by weight of cross-linking promoter with respect to 100 parts by weight of acryl-based resin syrup consisting of 10 to 50 percent by weight of acryl-based resin and 50 to 90 percent by weight of acryl-based monomer.

The document US2021/0087383 discloses heat-curable bio-based casting composition. The composition is comprising (a) one or more monofunctional and one or more polyfunctional acrylic and/or methacrylic biomonomers of vegetable or animal origin, (b) one or more polymers or copolymers selected from among polyacrylates, polymethacrylates, polyols, polyesters derived from recycled material or of vegetable or animal origin, and (c) inorganic filler particles of natural origin, where the proportion of the monofunctional and polyfunctional acrylic and methacrylic biomonomer(s) is 10-40 percent by weight, the proportion of the polymer(s) or copolymer(s) is 1-16 percent by weight and the proportion of the inorganic filler particles is 44-89 percent by weight.

The document U.S. Pat. No. 5,519,081 discloses polymerizable compositions. The composition comprises a curable methyl methacrylate, an inorganic filler and a functionalized polymer. Latter functionalized polymer could be a block copolymer, preferably obtained from diene and vinyl aromatic compound.

The document WO2017/164120 discloses a (meth)acrylic resin composition, resin molded body, resin layered body and method for manufacturing (meth)acrylic resin composition. The composition comprises a flame retardant and optionally an impact modifier which could comprise a block copolymer.

None of the prior art discloses a block copolymer in the composition or a block copolymer in a specific preferred composition.

### BRIEF DESCRIPTION OF THE INVENTION

Surprisingly it has been found that a (meth)acrylic composition MC1 comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) optionally from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer, and
(e) optionally from 0.01 part by weight to 5 parts by weight of a polymerization initiator;
   allows to provide a composition for the preparation of (meth)acrylic polymers or composites that possess a lower release of energy during polymerization as compared to a composition not comprising the component b). By lower release of energy during polymerization is meant, that the heat generated during the exothermic polymerization process is smaller, signifying a smaller temperature increase.

Surprisingly it has also been found that a (meth)acrylic composition MC1 comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) optionally from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer, and
(e) optionally from 0.01 part by weight to 5 parts by weight of a polymerization initiator;
   allows to provides a polymeric (meth)acrylic composite after polymerization of said (meth)acrylic composition MC1 that possess a lower gloss as compared to a composition not comprising the component b).

Surprisingly it has also been found that a (meth)acrylic composition MC1 comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) optionally from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer, and
(e) optionally from 0.01 part by weight to 5 parts by weight of a polymerization initiator;
   can be used to decrease the cycle time for polymerization of said (meth)acrylic composition MC1 as compared to a composition not comprising the component b).

Surprisingly it has been found that a process for preparing a polymeric composite material from a (meth)acrylic composition MC1, said method comprises the following steps:
i) providing the following components
   (a) 100 parts by weight of a liquid (meth)acrylic syrup comprising:
      (a₁) from 1% by weight to 50% by weight of one or more (meth)acrylic polymers P1, and
      (a₂) from 50% by weight to 99% by weight of one or more (meth)acrylic monomers M1, each monomer M1 comprising only one (meth)acrylic function per monomer,
   (b) from 0.5 parts by weight to 15 parts by weight of a block copolymer BC1,
   (c) from 20 parts by weight to 300 parts by weight of a mineral filler C,
   (d) from 0.01 part by weight to 5 parts by weight of a (meth)acrylic monomer M2, the monomer M2 comprising at least two (meth)acrylic functions per monomer, and
   (e) from 0.01 part by weight to 5 parts by weight of a polymerization initiator;
ii) mixing the components a) to e).
iii) polymerizing the (meth)acrylic composition MC1;
yields to a process for the preparation of polymeric (meth)acrylic composites that possess a lower release of energy during polymerization as compared to a process including composition not comprising the component b).

### BRIEF DESCRIPTION OF THE FIGURES

FIG. 1 shows temperature as a function of time during a polymerization as in the Examples.

FIG. 2 shows portion of the temperature as a function of time as shown in FIG. 1.

### DETAILED DESCRIPTION OF THE INVENTION

According to a first aspect, the present invention relates to a (meth)acrylic composition MC1, said composition is comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) optionally from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer.

According to a second aspect, the present invention relates to a (meth)acrylic composition MC1, said composition is comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer, and
(e) from 0.01 part by weight to 5 parts by weight of a polymerization initiator.

According to a third aspect, the present invention relates to a method for preparing a (meth)acrylic composition MC1 comprising following steps:
i) providing the following components:
   (a) 100 parts by weight of a liquid (meth)acrylic syrup comprising:
      (a₁) from 1% by weight to 50% by weight of one or more (meth)acrylic polymers P1, and
      (a₂) from 50% by weight to 99% by weight of one or more (meth)acrylic monomers M1, each monomer M1 comprising only one (meth)acrylic function per monomer,
   (b) from 0.5 parts by weight to 15 parts by weight of a block copolymer BC1,
   (c) optionally from 20 parts by weight to 300 parts by weight of a mineral filler C, and
   (d) from 0.01 part by weight to 5 parts by weight of a (meth)acrylic monomer M2, the monomer M2 comprising at least two (meth)acrylic functions per monomer; and
ii) mixing the components a) to d).

According to a fourth aspect, the present invention relates to a process for preparing a (meth)acrylic composition MC1, process is comprising following steps:
i) providing the following components:
   (a) 100 parts by weight of a liquid (meth)acrylic syrup comprising:
      (a₁) from 1% by weight to 50% by weight of one or more (meth)acrylic polymers P1, and
      (a₂) from 50% by weight to 99% by weight of one or more (meth)acrylic monomers M1, each monomer M1 comprising only one (meth)acrylic function per monomer,
   (b) from 0.5 parts by weight to 15 parts by weight of a block copolymer BC1,
   (c) from 20 parts by weight to 300 parts by weight of a mineral filler C,
   (d) from 0.01 part by weight to 5 parts by weight of a (meth)acrylic monomer M2, the monomer M2 comprising at least two (meth)acrylic functions per monomer, and
   (e) from 0.01 part by weight to 5 parts by weight of a polymerization initiator; and
ii) mixing the components a) to e).

According to a fifth aspect the present invention relates to the use of a (meth)acrylic composition MC1 to prepare a polymeric composite material, said (meth)acrylic composition MC1 comprises:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer.

According to a sixth aspect the present invention relates to use of a (meth)acrylic composition MC1 to prepare polymeric composite material, said (meth)acrylic composition MC1 comprises:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer, and
(e) from 0.01 part by weight to 5 parts by weight of a polymerization initiator.

According to a seventh aspect the present the present invention relates to a process for manufacturing a polymeric composite material from a (meth)acrylic composition MC1, said process comprises the following steps:
i) providing the following components
   (a) 100 parts by weight of a liquid (meth)acrylic syrup comprising:
      (a₁) from 1% by weight to 50% by weight of one or more (meth)acrylic polymers P1, and
      (a₂) from 50% by weight to 99% by weight of one or more (meth)acrylic monomers M1, each monomer M1 comprising only one (meth)acrylic function per monomer,
   (b) from 0.5 parts by weight to 15 parts by weight of a block copolymer BC1,
   (c) from 20 parts by weight to 300 parts by weight of a mineral filler C,
   (d) from 0.01 part by weight to 5 parts by weight of a (meth)acrylic monomer M2, the monomer M2 comprising at least two (meth)acrylic functions per monomer, and
   (e) from 0.01 part by weight to 5 parts by weight of a polymerization initiator;
ii) mixing the components a) to e).
iii) polymerizing the (meth)acrylic composition MC1.

According to an eight aspect the present the present invention relates to a process for reducing the cycle time for preparing a polymeric composite material from a (meth)acrylic composition MC1, said process comprises the following steps:
i) providing the following components
   (a) 100 parts by weight of a liquid (meth)acrylic syrup comprising:
      (a₁) from 1% by weight to 50% by weight of one or more (meth)acrylic polymers P1, and
      (a₂) from 50% by weight to 99% by weight of one or more (meth)acrylic monomers M1, each monomer M1 comprising only one (meth)acrylic function per monomer,
   (b) from 0.5 parts by weight to 15 parts by weight of a block copolymer BC1,
   (c) from 20 parts by weight to 300 parts by weight of a mineral filler C,
   (d) from 0.01 part by weight to 5 parts by weight of a (meth)acrylic monomer M2, the monomer M2 comprising at least two (meth)acrylic functions per monomer, and
   (e) from 0.01 part by weight to 5 parts by weight of a polymerization initiator;
ii) mixing the components a) to e).
iii) polymerizing the (meth)acrylic composition MC1

The term “(meth)acrylic monomer” covers both an acrylic monomer and a methacrylic monomer. Similarly, the term “(meth)acrylic polymer” covers not only an acrylic homopolymer but also a methacrylic homopolymer, an acrylic copolymer and a methacrylic copolymer.

By the term “PMMA” as used are denoted homo- and copolymers of methylmethacrylate (MMA), for the copolymer of MMA the weight ratio of MMA inside the PMMA is at least 50 wt %.

By the term “initiator” as used is denoted a chemical species that forms compound or an intermediate compound that starts the polymerization of a monomer, that to capable of linking successively with a large number of other monomers into a polymeric compound.

By the term “polymer composite” as used is denoted a multicomponent material comprising multiple different phase domains in which at least one type of phase domain is a continuous phase and in which at least one component is a polymer.

By the term “lower release of energy during polymerization” as used is meant, that the heat generated during the exothermic polymerization process is smaller, signifying a smaller temperature increase, for the composition of the invention.

By the term “thermoplastic” as used is denoted a polymer that turns to a liquid or becomes more liquid or less viscous when heated and that can take on new shapes by the application of heat and optionally pressure. This applies also for slightly crosslinked thermoplastic polymers that can be thermoformed when heated above the softening temperature.

By saying that a range from x to y in the present invention, it is meant that the upper and lower limit of this range are included, equivalent to at least x and up to y.

By saying that a range is between x and y in the present invention, it is meant that the upper and lower limit of this range are excluded, equivalent to more than x and less than y.

The liquid (meth)acrylic syrup (a) according to the invention comprises (a₁) a (meth)acrylic polymer P1 and (a₂) a (meth)acrylic monomer M1.

The liquid (meth)acrylic syrup (a) according to the (meth)acrylic composition MC1 of invention comprises between 1 wt % and 50 wt % of a (meth)acrylic polymer P1 and between 50 wt % and 99 wt % of a (meth)acrylic monomer M1. Preferably the liquid (meth)acrylic syrup comprises between 2 wt % and 50 wt % of a (meth)acrylic polymer P1 and between 50 wt % and 98 wt % of a (meth)acrylic monomer M1, more preferably between 2 wt % and 40 wt % of a (meth)acrylic polymer P1 and between 60 wt % and 98 wt % of a (meth)acrylic monomer M1, still more preferably between 3 wt % and 40 wt % of a (meth)acrylic polymer P1 and between 60 wt % and 97 wt % of a (meth)acrylic monomer M1, advantageously between 3 wt % and 35 wt % of a (meth)acrylic polymer P1 and between 65 wt % and 97 wt % of a (meth)acrylic monomer M1 and more advantageously between 3 wt % and 30 wt % of a (meth)acrylic polymer P1 and between 70 wt % and 97 wt % of a (meth)acrylic monomer M1.

The dynamic viscosity of the liquid (meth)acrylic syrup is in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s. The viscosity of the syrup can be easily measured with a Rheometer or viscosimeter. The dynamic viscosity is measured at 25° C. If the liquid (meth)acrylic syrup has a Newtonian behaviour, meaning no shear thinning, the dynamic viscosity is independent of the shearing in a rheometer or the speed of the mobile in a viscometer. If the liquid composition has a non-Newtonian behaviour, meaning shear thinning, the dynamic viscosity is measured at a shear rate of 1 s⁻¹ at 25° C.

As regards the liquid (meth)acrylic syrup (a), it comprises (a₁) the (meth)acrylic monomer M1 and (a₂) the (meth)acrylic polymer P1. Once the (meth)acrylic composition MC1 has been polymerized, the (meth)acrylic monomer M1 copolymerizes with (meth)acrylic monomer M2 and is transformed to a (meth)acrylic polymer P2 comprising the monomeric units of (meth)acrylic monomer M1 and (meth)acrylic monomer M2 and other possible comonomers.

The liquid (meth)acrylic syrup of the (meth)acrylic composition MC1 according to the invention may comprise only one (meth)acrylic polymer P1, but may equally comprise a mixture of two, three or even more (meth)acrylic polymers P1. If there is a mixture of different (meth)acrylic polymer P1, the difference is the composition of the respective (meth)acrylic polymer P1 or the molecular weight of the respective (meth)acrylic polymer P1 or both.

The or each (meth)acrylic polymer P1 included in the liquid (meth)acrylic syrup may in particular be chosen from:
polyalkyl acrylates which comprise alkyl acrylate homopolymers and alkyl acrylate copolymers, and
polyalkyl methacrylates which comprise alkyl methacrylate homopolymers and alkyl methacrylate copolymers.

According to a preferred embodiment, the or each (meth)acrylic polymer P1 is a polymethyl methacrylate (PMMA), it being understood that, as indicated above, the polymethyl methacrylate (PMMA) may denote a methyl methacrylate (MMA) homopolymer or an MMA copolymer.

In particular, in the case where the liquid (meth)acrylic syrup comprises a mixture of two or more polymethyl methacrylates P1, this mixture may be formed by mixing at least two MMA homopolymers having a different molecular weight, by mixing at least two MMA copolymers having an identical monomer composition and a different molecular weight, by mixing at least two MMA copolymers having a different monomer composition or by mixing at least one MMA homopolymer and at least one MMA copolymer.

According to a first preferred embodiment the (meth)acrylic polymer P1 is chosen from a methyl methacrylate homopolymer or a methyl methacrylate copolymer or a mixture thereof, methyl methacrylate advantageously representing at least 50% by weight of the or of each (meth)acrylic polymer P1.

According to one embodiment of the invention, methyl methacrylate represents at least 55% by weight of the or each (meth)acrylic polymer P1.

According to another particular embodiment, the or each (meth)acrylic polymer P1 comprises at least 70%, advantageously at least 80%, preferentially at least 90% and more preferentially at least 95% by weight of methyl methacrylate.

When the or each (meth)acrylic polymer P1 is a methyl methacrylate (MMA) copolymer, it may comprise at least one comonomer containing at least one ethylenic unsaturation and which is capable of copolymerizing with methyl methacrylate. Among these comonomers, mention may notably be made of acrylic and methacrylic acids and alkyl (meth)acrylates in which the alkyl group contains from 1 to 12 carbon atoms. Alkyl (meth)acrylates means an alkyl ester of acrylic acid or methacrylic acid. As examples of comonomers, mention may be made of methyl acrylate and ethyl, butyl or 2-ethylhexyl (meth)acrylate.

Advantageously, the or each (meth)acrylic polymer P1 is a homopolymer of methyl methacrylate or a copolymer of methyl methacrylate and of an alkyl acrylate or an alkyl methacrylate in which the alkyl group contains from 1 to 12 carbon atoms, advantageously from 1 to 6 carbon atoms and preferentially from 1 to 4 carbon atoms.

According to a first preferred embodiment, when the or each (meth)acrylic polymer P1 is a methyl methacrylate (MMA) copolymer, this methyl methacrylate (MMA) copolymer comprises from 70% to 99.9%, advantageously from 80% to 99.9%, preferentially from 90% to 99.9% and more preferentially from 95% to 99.9% by weight of methyl methacrylate and from 0.1% to 30%, advantageously from 0.1% to 20%, preferentially from 0.1% to 10% and more preferentially from 0.1% to 5% by weight of at least one comonomer containing at least one ethylenic unsaturation that can copolymerize with methyl methacrylate. Preferably, the or each comonomer is chosen from methyl acrylate and ethyl acrylate.

In an advantageous variant of the first preferred embodiment, when the or each (meth)acrylic polymer P1 is a methyl methacrylate (MMA) copolymer, the (meth)acrylic polymer P1 is a copolymer of methyl methacrylate and of alkyl acrylate.

In a preferred variant of the first preferred embodiment, when the or each (meth)acrylic polymer P1 is a methyl methacrylate (MMA) copolymer, the (meth)acrylic polymer P1 is a copolymer of methyl methacrylate and of methyl acrylate or ethylacrylate.

According to a second preferred embodiment, when the or each (meth)acrylic polymer P1 is a methyl methacrylate (MMA) copolymer, this methyl methacrylate (MMA) copolymer comprises from 50% to 99.9%, advantageously from 52% to 99.9%, preferentially from 53% to 99.9% and more preferentially from 55% to 99.9% by weight of methyl methacrylate and from 0.1% to 50%, advantageously from 0.1% to 48%, preferentially from 0.1% to 47% and more preferentially from 0.1% to 45% by weight of at least one comonomer containing at least one ethylenic unsaturation that can copolymerize with methyl methacrylate. Preferably, the or each comonomer is chosen from methyl acrylate, ethyl acrylate, ethyl methacrylate, propyl acrylate, propyl methacrylate, butyl acrylate or butyl methacrylate.

The weight-average molecular weight, noted as M_{W}, of the or each (meth)acrylic polymer P1 is generally high and may consequently be greater than 40 000 g/mol, advantageously greater than 45 000 g/mol and preferentially greater than 50 000 g/mol. The weight-average molecular weight may be measured by size exclusion chromatography (SEC).

The (meth)acrylic polymer P1, if not crosslinked, usually has a melt mass-flow rate (MFR) ISO 1133-2:2011 (230° C./3.8 kg) of between 0.1 g/10 min and 20 g/10 min or the melt mass-flow rate is between 0.2 g/10 min and 18 g/10 min, or between 0.3 g/10 min and 16 g/10 min or between 0.4 g/10 min and 13 g/10 min.

The liquid (meth)acrylic syrup of the (meth)acrylic composition MC1 according to the invention may comprise only one (meth)acrylic monomer M1, but may equally comprise a mixture of two, three or even more (meth)acrylic monomers M1. This would be (meth)acrylic monomer M1a, (meth)acrylic monomer M1b, (meth)acrylic monomers M1c and so on.

Whether the liquid (meth)acrylic syrup comprises one or more (meth)acrylic monomers M1, the or each (meth)acrylic monomer M1 comprises only one (meth)acrylic function per monomer.

As regards the (math) acrylic monomer (M1), the monomer is chosen from alkyl acrylic monomers, alkyl methacrylic monomers, hydroxyalkyl acrylic monomers and hydroxyalkyl methacrylic monomers, and mixtures thereof. Alkyl acrylic monomer or alkyl methacrylic monomer means an alkyl ester of acrylic acid or methecrylic acid.

Preferably, the (meth)acrylic monomer (M1) is chosen from hydroxyalkyl acrylic monomers, hydroxyalkyl methacrylic monomers, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons.

Advantageously, the (meth)acrylic monomer (M1) is chosen from methyl methacrylate, ethyl methacrylate, methyl acrylate, ethyl acrylate, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

According to a preferred embodiment, at least 50% by weight and preferably at least 60% by weight of the (meth)acrylic monomer (M1) is methyl methacrylate.

According to a first more preferred embodiment, at least 50% by weight, preferably at least 60% by weight, more preferably at least 70% by weight, advantageously at least 80% by weight and even more advantageously 90% by weight of the monomer (M1) is a mixture of methyl methacrylate with optionally at least one other monomer.

In a first variant of the invention, the liquid (meth)acrylic syrup comprises:
(a₁) from 3% by weight to 27% by weight and preferentially from 3% by weight to 24% by weight of the (meth)acrylic polymer(s) P1, and
(a₂) from 77% by weight to 97% by weight and preferentially from 76% by weight to 97% by weight of the (meth)acrylic monomer(s) M1.

In a second variant of the invention, the liquid (meth)acrylic syrup comprises:
(a₁) from 3% by weight to 25% by weight and preferentially from 4% by weight to 25% by weight and more preferentially from 5% by weight to 25% by weight and even more preferentially from 5% by weight to 24% by weight of the (meth)acrylic polymer(s) P1, and
(a₂) from 75% by weight to 97% by weight and preferentially from 75% by weight to 96% by weight and more preferentially from 75% by weight to 95% by weight and even more preferentially from 76% by weight to 95% by weight of the (meth)acrylic monomer(s) M1.

In a third variant of the invention, the liquid (meth)acrylic syrup comprises:
(a₁) from 5% by weight to 25% by weight and preferentially from 5.5% by weight to 25% by weight and more preferentially from 6% by weight to 25% by weight and even more preferentially from 6% by weight to 24% by weight of the (meth)acrylic polymer(s) P1, and
(a₂) from 75% by weight to 95% by weight and preferentially from 75% by weight to 94.5% by weight and more preferentially from 75% by weight to 94% by weight and even more preferentially from 76% by weight to 94% by weight of the (meth)acrylic monomer(s) M1.

In an advantageous variant, the or each (meth)acrylic polymer P1 and the or each (meth)acrylic monomer M1 of the liquid (meth)acrylic syrup comprise at least one same (meth)acrylic unit, such a variant making it possible to optimize the solubility of the (meth)acrylic polymer(s) P1 in the (meth)acrylic monomer(s) M1.

Preferentially, the or each (meth)acrylic polymer P1 is chosen from a homopolymer of methyl methacrylate or copolymer of methyl methacrylate and of methyl acrylate and a copolymer of methyl methacrylate and of ethyl acrylate or a copolymer of methyl methacrylate and of butyl acrylate or a copolymer of methyl methacrylate and of butyl methacrylate, the respective comonomer being present at most at 45 wt % in the copolymer.

Preferentially, the (meth)acrylic monomer M1 is methyl methacrylate.

In a first advantageous variant, the liquid (meth)acrylic syrup comprises a (meth)acrylic polymer P1, rather than a mixture of (meth)acrylic polymers P1.

In a second advantageous variant, the liquid (meth)acrylic syrup comprises a mixture of two (meth)acrylic polymers P1.

In another advantageous variant, the liquid (meth)acrylic syrup comprises a (meth)acrylic monomer M1, rather than a mixture of (meth)acrylic monomers M1.

Stabilizers, or reaction inhibitors, may also be present in the liquid (meth)acrylic syrup to prevent spontaneous polymerization of the (meth)acrylic monomer(s) M1.

These stabilizers may notably be chosen from hydroquinone (HQ), hydroquinone monomethyl ether (HQME), 2,6-di-tert-butyl-4-methylphenol (BHT), 2,6-di-tert-butyl-4-methoxyphenol (Topanol O) and 2,4-dimethyl-6-tert-butylphenol (Topanol A).

These stabilizers may be present, in the liquid (meth)acrylic syrup, in a proportion of not more than 5 parts by weight, advantageously not more than 4 parts by weight and preferentially in a proportion of between 0.3 and 3 parts by weight, per 100 parts by weight of the (meth)acrylic polymer(s) P1 and of the (meth)acrylic monomer(s) M1.

As regards the (math) acrylic monomer (M2), the monomer is multifunctional. Preferably the (meth)acrylic monomer (M2) is chosen from a compound comprising at least two (meth)acrylic functions. The (meth)acrylic monomer (M2) can also be chosen from a mixture of at least two compounds (M2a) and (M2b) each comprising at least two (meth)acrylic functions.

The (meth)acrylic monomer (M2) can be chosen from 1,3-butylene glycol dimethacrylate; 1,4-butanediol dimethacrylate; 1,6 hexanediol diacrylate; 1,6 hexanediol dimethacrylate; diethylene glycol dimethacrylate; dipropylene glycol diacrylate; ethoxylated (10) bisphenol a diacrylate; ethoxylated (2) bisphenol a dimethacrylate; ethoxylated (3) bisphenol a diacrylate; ethoxylated (3) bisphenol a dimethacrylate; ethoxylated (4) bisphenol a diacrylate; ethoxylated (4) bisphenol a dimethacrylate; ethoxylated bisphenol a dimethacrylate; ethoxylated (10) bisphenol dimethacrylate; ethylene glycol dimethacrylate; polyethylene glycol (200) diacrylate; polyethylene glycol (400) diacrylate; polyethylene glycol (400) dimethacrylate; polyethylene glycol (400) dimethacrylate; polyethylene glycol (600) diacrylate; polyethylene glycol (600) dimethacrylate; polyethylene glycol 400 diacrylate; propoxylated (2) neopentyl glycol diacrylate; tetraethylene glycol diacrylate; tetraethylene glycol dimethacrylate; tricyclodecane dimethanol diacrylate; tricyclodecanedimethanol dimethacrylate; triethylene glycol diacrylate; triethylene glycol dimethacrylate; tripropylene glycol diacrylate; ethoxylated (15) trimethylolpropane triacrylate; ethoxylated (3) trimethylolpropane triacrylate; ethoxylated (6) trimethylolpropane triacrylate; ethoxylated (9) trimethylolpropane triacrylate; ethoxylated 5 pentaerythritol triacrylate; ethoxylated (20) trimethylolpropane triacrylate; propoxylated (3) glyceryl triacrylate; trimethylolpropane triacrylate; propoxylated (5.5) glyceryl triacrylate; pentaerythritol triacrylate; propoxylated (3) glyceryl triacrylate; propoxylated (3) trimethylolpropane triacrylate; trimethylolpropane triacrylate; trimethylolpropane trimethacrylate; tris(2-hydroxy ethyl) isocyanurate triacrylate; di-trimethylolpropane tetraacrylate; dipentaerythritol pentaacrylate; ethoxylated (4) pentaerythritol tetraacrylate; pentaerythritol tetraacrylate; dipentaerythritol hexaacrylate; 1,10 decanediol diacrylate; 1,3-butylene glycol diacrylate; 1,4-butanediol diacrylate; 1,9-nonanediol diacrylate; 2-(2-Vinyloxyethoxy)ethyl acrylate; 2-butyl-2-ethyl-1,3-propanediol diacrylate; 2-methyl-1,3-propanediol diacrylate; 2-methyl-1,3-propanediyl ethoxy acrylate; 3 methyl 1,5-pentanediol diacrylate; alkoxylated cyclohexane dimethanol diacrylate; alkoxylated hexanediol diacrylate; cyclohexane dimethanol diacrylate; ethoxylated cyclohexane dimethanol diacrylate; diethyleneglycol diacrylate; dioxane glycol diacrylate; ethoxylated dipentaerythritol hexaacrylate; ethoxylated glycerol triacrylate; ethoxylated neopentyl glycol diacrylate; hydroxypivalyl hydroxypivalate diacrylate; neopentyl glycol diacrylate; poly (tetramethylene glycol) diacrylate; polypropylene glycol 400 diacrylate; polypropylene glycol 700 diacrylate; propoxylated (6) ethoxylated bisphenol A diacrylate; propoxylated ethylene glycol diacrylate; propoxylated (5) pentaerythritol tetraacrylate; and propoxylated trimethylol propane triacrylate; or mixtures thereof.

The (meth)acrylic monomer (M2) can be present in (meth)acrylic composition MC1 between 0.01 and 5 phr by weight, for 100 parts of a liquid (meth)acrylic syrup, more preferably between 0.1 and 4.5 phr, even more preferably between 0.1 and 4 phr and advantageously between 0.1 and 3 phr.

In a first more preferred embodiment the (meth)acrylic monomer (M2) is present in (meth)acrylic composition MC1 between 0.1 and 5 phr and is chosen from a compound comprising two (meth)acrylic functions.

In a second more preferred embodiment the (meth)acrylic monomer (M2) is present in (meth)acrylic composition MC1 between 0.1 and 5 phr and is chosen from a mixture of compounds comprising two (meth)acrylic functions.

In a third more preferred embodiment the (meth)acrylic monomer (M2) is present in (meth)acrylic composition MC1 between 0.1 and 4 phr and is chosen from a mixture of compounds comprising at least two (meth)acrylic functions.

In a fourth more preferred embodiment the (meth)acrylic monomer (M2) is present in (meth)acrylic composition MC1 between 0.1 and 3 phr and is chosen from a mixture of compounds comprising at least two (meth)acrylic functions. At least one compound of the mixture comprises only two (meth)acrylic functions and presents at least 50 wt % of the mixture of (meth)acrylic monomer (M2), preferably at least 60 wt %.

In a fifth more preferred embodiment the (meth)acrylic monomer (M2) is present in (meth)acrylic composition MC1 between 0.2 and 4 phr and is chosen from a mixture of compounds comprising at least two (meth)acrylic functions.

In a sixth more preferred embodiment the (meth)acrylic monomer (M2) is present in (meth)acrylic composition MC1 between 0.3 and 4 phr and is chosen from a mixture of compounds comprising at least two (meth)acrylic functions.

The (meth)acrylic composition MC1 according to the invention may also comprises a mineral filler C.

The mineral filler C may notably comprise a filler C1 chosen from quartz, granite, marble, feldspar, clay, glass, ceramics, mica, graphite, silicates, carbonates, carbides, sulfates, silicates, hydroxides, metal oxides, metals and mixtures thereof.

According to a particular embodiment, the filler C1 is in powder form.

Such a powder may be formed, for example, from particles, of which at least 50% by number have a mean particle size, noted as D₅₀, of less than or equal to 50 μm, advantageously less than or equal to 20 μm and preferentially less than or equal to 5 μm.

When the filler C1 is chosen from sulfates, this or these sulfates may be chosen from alkali metal and alkaline-earth metal sulfates, preferably magnesium sulfate, calcium sulfate, strontium sulfate and barium sulfate.

When the filler C1 is chosen from metal oxides, this or these metal oxides may be chosen from alumina Al₂O₃, which may or may not be hydrated, barium oxide BaO, silica SiO₂, magnesium oxide MgO and calcium oxide CaO.

According to a first preferred embodiment, the metal oxide is silica SiO₂. This silica may notably be a ground crystalline silica or an amorphous silica.

When the filler C1 is chosen from carbonates, this or these carbonates may be chosen from calcium carbonate (chalk), magnesium carbonate, sodium carbonate and potassium carbonate.

When the filler C1 is chosen from silicates, this or these silicates may be chosen from calcium silicate, sodium silicate, potassium silicate and magnesium silicate.

In one variant of the invention, the mineral filler C may also further comprise aluminium trihydrate Al(OH)₃, noted as C2, and/or reinforcers, noted as C3.

The presence of aluminium trihydrate C2 makes it possible in particular to improve the machining of the composite material obtained from the (meth)acrylic composition MC1 according to the invention and also the fire resistance properties of this material.

According to a particular embodiment, the aluminium trihydrate C2 is in the form of particles, of which at least 50% by number have a mean particle size, noted as D₅₀, of less than or equal to 50 μm, advantageously less than or equal to 20 μm and preferentially less than or equal to 5 μm.

The reinforcers C3 may notably be in the form of fibers or beads. These fibers may be natural or synthetic, and short or long.

In an advantageous variant of the invention, the reinforcers C3 may be chosen from glass fabrics, glass fibers and glass beads.

The (meth)acrylic composition MC1 according to the invention comprises from 20 parts by weight to 300 parts by weight of mineral filler C for 100 parts by weight of the liquid (meth)acrylic syrup.

According to a particular embodiment, the (meth)acrylic composition MC1 according to the invention comprises from 30 parts by weight to 280 parts by weight, advantageously from 50 parts by weight to 250 parts by weight, preferentially from 60 parts by weight to 230 parts by weight, more preferentially from 80 parts by weight to 200 parts by weight and even more preferentially from 100 parts by weight to 200 parts by weight of mineral filler C.

The (meth)acrylic composition MC1 according to the invention, may also be used for impregnating a fibrous substrate or to be mixed with short fibres.

As regards the block copolymer BC1, it can be chosen from a thermoplastic block copolymer.

Advantageously the block copolymer is amorphous. More advantageously the block copolymer does not comprise any semi-crystalline or crystalline blocks.

The block copolymer BC1 comprises at least one block having a glass transition temperature Tg less than 20° C., preferably less than 10° C.; and more preferably less than 0° C.

Preferably one of the at least other blocks is having a glass transition temperature Tg more than 20° C., preferably more than 30° C., more preferably more than 40° C.; and even more preferably more than 50° C.

Most preferably the thermoplastic block copolymer is a thermoplastic acrylic block copolymer. By this is meant that at least 30% wt %, preferably 40 wt % and more preferably 50 wt % of the monomers inside thermoplastic acrylic block copolymer are alkyl(meth)acrylate monomers.

Preferably the thermoplastic acrylic block copolymer is having a general formula (A)ₙB in which:
n is an integer of greater than or equal to 1,
A is: an acrylic or methacrylic or styrenic homo- or copolymer having a Tg of greater than 50° C., preferably of greater than 80° C., or polystyrene, or an acrylic/styrene or methacrylic/styrene copolymer;
B is an acrylic or methacrylic or homo- or copolymer having a Tg of less than 20° C., preferably less than 10° C. and more preferably less than 0° C.

Preferably, in the block A the monomer is chosen from methyl methacrylate (MMA), phenyl methacrylate, benzyl methacrylate, isobornyl methacrylate, styrene (Sty) or alpha-methylstyrene or mixtures thereof. More preferably, the block A is PMMA or PMMA copolymerized with acrylic or methacrylic comonomers or polystyrene (PS) or PS modified with styrenic comonomers.

Preferably the block B comprises monomers chosen of methyl acrylate, ethyl acrylate, butyl acrylate (BuA), ethylhexyl acrylate or butyl methacrylate and mixtures thereof, more preferably butyl acrylate said monomers make up at least 50 wt %, preferably 70 wt % of block B.

Furthermore, the blocks A and/or B can comprise other acrylic or methacrylic comonomers carrying various chemical function groups known to a person skilled in the art, for example acid, amide, amine, hydroxyl, epoxy or alkoxy functional groups. The block A can also incorporate groups, such as acrylic acid (AA) or methacrylic acid (MAA), in order to increase the thermal resistance of thereof.

Comonomers like styrene can also be incorporated in the block B in order to mismatch the refractive index of the block A.

Preferably, said thermoplastic acrylic block copolymer has a structure chosen from: ABA, AB, A₃B and A₄B.

The thermoplastic acrylic block copolymer for example can be one of the following triblock copolymers: pMMA-pBuA-pMMA, p(MMAcoMAA)-pBuA-p(MMAcoMAA), pMMA-p(BuAcoSty)-pMMA, p(MMAcoMAA)-p(BuAcoSty)-p(MMAcoMAA) and pMMA-p(BuAcoAA)-pMMA. In a first preferred embodiment, the block copolymer is of MMA type (PMMAcoMAA)-p(BuAcoSty)-P(MMAcoMAA).

It is also known to a person skilled in the art that the polymers of PMMA type can comprise small amounts of acrylate comonomer in order to improve the thermal stability thereof. By small is meant less than 9 wt %, preferably less than 7 wt % and more preferably less than 6 wt %.

The block B represents from 10 wt % to 85 wt % of the total weight of the block copolymer BC1, preferably 25 wt % to 75 wt % and more preferably from 35 wt % to 65 wt %.

The block copolymer BC1 has a weight-average molar mass of between 10 000 g/mol and 500 000 g/mol, preferably between 20 000 g/mol and 300 000 g/mol and more preferably between 20 000 g/mol and 200 000 g/mol.

The block copolymers participating in the composition of the invention can be obtained by controlled radical polymerization (CRP) or by anionic polymerization; the most suitable process according to the type of copolymer to be manufactured will be chosen.

If the process is CRP, it can be in particular in the presence of nitroxides, for the block copolymers of (A)ₙB type and anionic or nitroxide radical polymerization, for the structures of ABA type, such as the triblock copolymer.

According to a first more preferred embodiment the (meth)acrylic composition MC1 comprises from 0.6 parts by weight to 15 parts by weight of a block copolymer BC1.

According to a second more preferred embodiment the (meth)acrylic composition MC1 comprises from 0.5 parts by weight to 10 parts by weight of a block copolymer BC1.

According to a third more preferred embodiment the (meth)acrylic composition MC1 comprises from 0.5 parts by weight to 7 parts by weight of a block copolymer BC1.

According to a fifth more preferred embodiment the (meth)acrylic composition MC1 comprises from 0.5 parts by weight to 6 parts by weight of a block copolymer BC1.

The (meth)acrylic composition MC1 according to the invention also comprises a polymerization initiator, the function of which is to ensure the start of polymerization of the (meth)acrylic monomers M1 and M2.

The polymerization initiator may be chosen from organic peroxides, peroxy esters, peroxy acetals and azo compounds.

The polymerization initiator may in particular comprise from 2 to 30 carbon atoms and may be chosen, for example, from tert-amyl peroxyneodecanoate, di(sec-butyl) peroxydicarbonate, diisopropyl peroxydicarbonate, tert-butyl peroxyneodecanoate, bis(2-ethylhexyl) peroxydicarbonate, tert-amyl peroxypivalate, tert-butyl peroxypivalate, bis(3,5,5-trimethylhexanoyl) peroxide, 2,5-dimethyl-2,5-bis(2-ethylhexanoylperoxy)hexane, 1,1,3,3-tetramethylbutyl peroxy-2-ethylhexanoate, tert-amyl peroxy-2-ethylhexanoate, tert-butyl peroxy-2-ethylhexanoate, tert-butyl peroxydiethylacetate, tert-butyl peroxyisobutyrate, tert-amylperoxy-1-methoxycyclohexane, 1,1-di(tert-amylperoxy)cyclohexane, 1,1-di(tert-butylperoxy)-3,3,5-trimethylcyclohexane, 1,1-di(tert-butylperoxy)cyclohexane, tert-amyl peroxy-2-ethylhexylcarbonate, tert-butyl peroxy-2-ethylhexylcarbonate, tert-amyl peroxy-3,5,5-trimethylhexanoate, tert-butyl peroxy-3,5,5-trimethylhexanoate, tert-amyl peroxyacetate, tert-butyl peroxyacetate, 2,2-di(tert-butylperoxy)butane, 2,2-di(tert-amylperoxy)butane, tert-amyl peroxybenzoate, tert-butyl peroxybenzoate, butyl 4,4-di(tert-butylperoxy)valerate, 2,5-dimethyl-2,5-di(tert-butylperoxy)hexane, tert-butylcumyl peroxide, di-tert-amyl peroxide, di-tert-butyl peroxide, 1,1,3,3-tetramethylbutyl hydroperoxide, 3,5-diisopropylbenzene hydroperoxide, cumene hydroperoxide and mixtures thereof.

The (meth)acrylic composition according to the invention may comprise from 0.01 part by weight to 5 parts by weight of polymerization initiator.

According to a particular embodiment, the (meth)acrylic composition according to the invention comprises from 0.02 part by weight to 4 parts by weight and advantageously 0.03 part by weight to 3 parts by weight of polymerization initiator per 100 parts by weight of the liquid (meth)acrylic syrup.

That which has just been described for a polymerization initiator is entirely transposable to an initiator system, such a system consisting of a polymerization initiator and a polymerization activator or accelerator.

The (meth)acrylic composition according to the invention may also effectively further comprise a polymerization activator or accelerator.

According to a particular embodiment, the (meth)acrylic composition according to the invention comprises from 0.01 part by weight to 1 part by weight, advantageously from 0.02 part by weight to 0.9 part by weight and preferably from 0.03 part by weight to 0.7 part by weight of polymerization activator or accelerator per 100 parts by weight of the(meth)acrylic syrop.

The present invention relates to a process for manufacturing a (meth)acrylic composition MC1.

According to the invention, this process comprises the steps: i) providing the components a) to d) or a) to e) and ii) mixing the components a) to d) or a) to e).

Step ii) of the manufacturing process according to the invention is performed by mixing all of the compounds included in the (meth)acrylic composition MC1, care being taken to prepare, firstly, the liquid (meth)acrylic syrup and then to introduce, into this (meth)acrylic syrup, the (meth)acrylic monomers M2 and the block copolymer BC1 and, where appropriate, the polymerization activator or accelerator, and also the mineral filler C, the polymerization initiator being introduced last.

In one embodiment, the block copolymer BC1 is in form of particles in order to have an easier dispersion and dissolution. The particles have preferably a weight average particle size smaller than 800 μm. More preferably the weight average particle size is between 40 μm and 500 μm and still more preferably between 50 μm and 300 μm.

This mixing may be manual or may be performed using a mixer.

Optionally, the mixing is performed under a gentle vacuum so as to remove the reaction gases, typically between 80 mbar and 1 bar, advantageously between 100 mbar and 1 bar, more advantageously between 500 mbar and 900 mbar, and for a time of between 1 minutes and 6 hours, advantageously between 2 minutes and 2 hours, more advantageously between 3 minutes and 1 hour and preferentially between 4 minutes and 1 hour.

Other methods of degassing are possible.

The manufacturing process according to the invention is thus a process that is particularly simple to perform and which may be readily performed in the current facilities dedicated to the manufacture of (meth)acrylic composition.

The (meth)acrylic composition MC1 comprising the compounds a) to d) or a) to e) has a viscosity between 50 mPa*s and 10 000 Pa*s at 23° C.

Preferably the viscosity of (meth)acrylic composition MC1 comprising the compounds a) to d) or a) to e) at 23° C.; is in a range from 50 mPa*s to 7 000 Pa*s, more preferably from 50 mPa*s to 5 000 Pa*s, still more preferably from 50 mPa*s to 2 500 Pa*s, even still more preferably from 50 mPa*s to 1 000 mPa*s, even still more preferably between 50 mPa*s and 500 Pa*s, advantageously between 50 mPa*s and 20 000 mPa*s and more advantageously between 50 mPa*s and 15 000 mPa*s.

The different preferred or more preferred or advantageous embodiments for the respective different components (a) to (e) of the (meth)acrylic composition MC1 can be combine in any combination. For example the more preferred weight-average molar weight of block copolymer BC1 can be combined with a preferred ratio of the (meth)acrylic monomer (M2) in (meth)acrylic composition MC1 or an advantageous ratio of MMA in (meth)acrylic polymer P1.

The present invention relates in an additional aspect to a composite material.

According to the invention, this composite material is obtained by polymerization of a (meth)acrylic composition MC1 as defined above comprising compounds a) to e).

According to the invention, the composite material is as defined above, i.e. it is obtained by polymerization of a (meth)acrylic composition MC1 in accordance with what has just been described, notably as regards the features relating to the (meth)acrylic composition MC1, the advantageous features of this (meth)acrylic composition MC1 being able to be taken alone or in combination.

The present invention relates in an additional aspect to composite material comprising the (meth)acrylic composition MC1 after polymerization of said (meth)acrylic composition MC1.

The invention relates also to the uses of the (meth)acrylic composition MC1 and of the composite material as defined above, the advantageous features of this (meth)acrylic composition and of these composite materials being able to be taken alone or in combination.

The (meth)acrylic composition MC1 according to the invention may be used for the manufacture of composite parts, notably with a thermoplastic matrix.

The (meth)acrylic composition MC1 and the composite materials according to the invention may be used in many sectors and notably in the housing, motor vehicle, railway, sports, aeronautical industry, aerospace, photovoltaic or wind power sector, and in marine applications and medical applications.

The (meth)acrylic composition MC1 may be used to prepare (meth)acrylic mineral composite and the composite material in one embodiment is a (meth)acrylic mineral composite.

By way of example, in the housing sector, these materials may be used for making bathroom and/or kitchen equipment, such as countertops, kitchen sinks, bathroom sinks, shower trays, baths tubes or fascia panels.

The present invention relates in an additional aspect to the use of the composite material for the fabrication of bathroom and/or kitchen equipment, such as countertops, kitchen sinks, bathroom sinks, shower trays, baths tubes or fascia panels.

The present invention relates in another additional aspect to the use of the composite material for bathroom and/or kitchen equipment, such as countertops, kitchen sinks, bathroom sinks, shower trays, baths tubes or fascia panels.

### [Methods]

The weight-average molecular weight may be measured by size exclusion chromatography (SEC). The chromatography column is calibrated with PMMA standards having a molecular weight between 402 g/mol and 1 900 000 g/mol. The average molecular weight are expressed in g/mol for the number and average molecular weight Mn and Mw respectively. For the measurement the concentration is 1 g/L.

The viscosity of the (meth)acrylic compositions comprising at least the components a), b), c) and d) is measured with a Brookfield viscosimeter at 23° C., according to ISO 2555:2018 “Plastics—Resins in the liquid state or as emulsions or dispersions—Determination of apparent viscosity using a single cylinder type rotational viscometer method”.

Gloss is measured according to ASTM D523 “Standard test Method for Specular Gloss”. Measurement is made on samples that have been kept 24 hour at a humidity of 50%±10% at a temperature of 23° C.±t2° C. Measurement is made before a black background.

### EXAMPLES

The compounds used for the preparation of the various (meth)acrylic compositions are the following:
as (meth)acrylic polymer P1: a PMMA formed by a copolymer of methyl methacrylate and of ethyl acrylate, from company Altuglas under the name Altuglas® BS 520B,
as (meth)acrylic monomer M1: a methyl methacrylate stabilized with hydroquinone monomethyl ether,
as mineral filler C: aluminium tri hydroxide—Al(OH)₃,
as (meth)acrylic monomer M2: an ethylene glycol dimethacrylate (EGDMA) from Sartomer under the name SR 206,
   as polymerization initiator: tert-Butyl peroxymaleate from the company Pergan under the name Peroxan PM-25 S,
   as blockcopolymer BC1: a triblockcopolymer comprising a center block of poly (butyl acrylate-co styrene) and two side blocks of poly (methyl methacrylate) made according to the process described in for example in EP1468029 and EP1526138. Such copolymers are available from ARKEMA under the name Nanostrength®.

A syrup S1 is prepared by first dissolving 25 parts by weight of the PMMA (BS520 a copolymer of MMA comprising ethyl acrylate as a comonomer) as P1 in 75 parts by weight of methyl methacrylate as M1, which is stabilized with MEHQ (hydroquinone monomethyl ether).

Syrup 51 is used to prepare the composition of the examples of the invention and comparative examples by adding additional compounds.

To 100 parts of syrup 51 then 0.6 parts by weight of SR206 are added as M2. Different quantities of blockcopolymer BC1 are added as BC1 and are dissolved under stirring during 15 min at 25° C.; in syrup 51.

Also 400 ppm of pentaerythritol tetrakis(3-mercaptopropionate) (PETMP) are added.

Then are added 173.7 phr of ATH as mineral filler C. Also are added 1 phr of BYK 969.

Finally, 0.76 phr of anhydrous CaOH as accelerator and 1.34 of Peroxan PM-25 S as initiator are added.

TABLE 1
prepared compositions in phr if not indicated otherwise

| | | 1 | 2 |
|---|---|---|---|
| Methacrylic | | (according to | (according to |
| composition | (comparative) | the invention) | the invention) |
| M1 + P1 | 100 | 100 | 100 |
| BC1 | 0 | 2 | 5 |
| EGDMA (M2) | 0.6 | 0.6 | 0.6 |
| PETMP | 400 ppm | 400 ppm | 400 ppm |
| ATH | 173.7 | 173.7 | 173.7 |
| Initiator | 1.34 | 1.34 | 1.34 |
| Accelerator | 0.76 | 0.76 | 0.76 |
| BYK969 | 1 | 1 | 1 |

The mixtures from table 1 are polymerized in two different ways.

In a first way, 250 g of each compositions are prepared in a recipient and the temperature is measured with the aid of a thermo sensor in order to measure the temperature as a function of time for following the kinetic and heat generated by the exothermic polymerization reaction.

In a second way, a composite is prepared in form of a sheet. The reaction mixtures are poured between two glass sheets of a dimension of 27 cm×27 cm separated by a gasket. The final sheet has a thickness of 4 mm. The gloss of each sheet is measured at 85°.

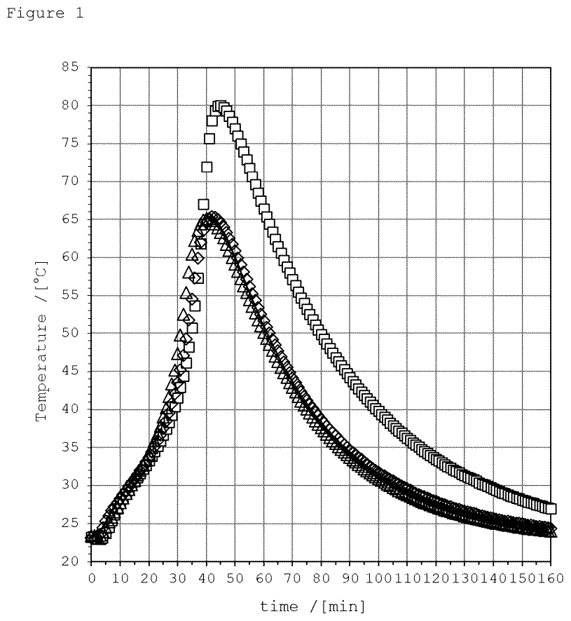

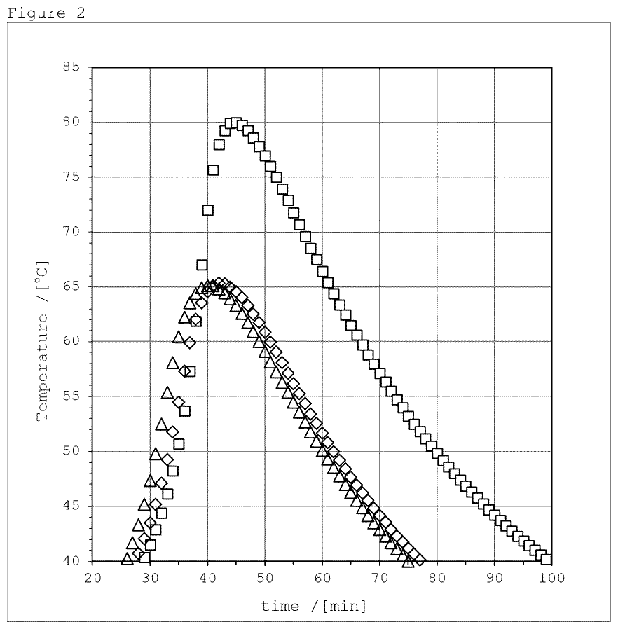

The temperature as function of time during the polymerization is presented in FIGS. 1 and 2. FIGS. 1 and 2 represent the same result, but for a better visibility of the respective points FIG. 2 shows only a part of global FIG. 1. FIGS. 1 and 2 show that the temperature for example 1 (⋄diamond), example 2 (Δtriangle) according to the invention and comparative example (□square). The peak of the temperature which for the examples 1 and 2 is much less than comparative example The temperature for the examples 1 and 2 is reduced to a lower level of temperature much faster than comparative example. This signifies a better handling of exothermic polymerization reaction, faster kinetic and process implying reduced cycle times.

The gloss of the sheets is measured.

TABLE 2
gloss measurements on the sheets obtained from the
respective compositions

| | | 1 | 2 |
|---|---|---|---|
| Methacrylic | | (according to | (according to |
| composition | (comparative) | the invention) | the invention) |
| Gloss at 85° | 37.7 | 12 | 6.6 |

Table 2 shows a much lower gloss for the composites obtained with the (meth)acrylic composition according to the invention. Thus the obtained composite with mineral filler has a surface aspect as natural material.

1. A (meth)acrylic composition MC1 comprising:
(a) 100 parts by weight of a liquid (meth)acrylic syrup comprising:
(a1) from 1% by weight to 50% by weight of one or more (meth)acrylic polymers P1, and
(a2) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) optionally from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer, and
(e) optionally from 0.01 part by weight to 5 parts by weight of a polymerization initiator.

2. The (meth)acrylic composition MC1 according to claim 1, characterized in that it further comprises
(c) from 20 parts by weight to 300 parts by weight of a mineral filler C

3. The (meth)acrylic composition MC1 according to claim 1, characterized in that it further comprises
(e) from 0.01 part by weight to 5 parts by weight of a polymerization initiator.

4. The composition according to claim 1, characterized in that each (meth)acrylic polymer P1 is chosen from a methyl methacrylate homopolymer or a methyl methacrylate copolymer or a mixture thereof, methyl methacrylate advantageously representing at least 50% by weight of each (meth)acrylic polymer P1.

5. The composition according to claim 1, characterized in that the block copolymer BC1 comprises at least one block having a glass transition temperature Tg less than 20° C. and at least another block is having a glass transition temperature Tg more than 20° C.

6. The composition according to claim 1, characterized in that the block copolymer BC1 is a thermoplastic acrylic block copolymer.

7. The composition according to claim 1, characterized in that mineral filler C comprises a filler C1 chosen from quartz, granite, marble, feldspar, clay, glass, ceramics, mica, graphite, silicates, carbonates, carbides, sulfates, silicates, hydroxides, metal oxides, metals and mixtures thereof.

8. The composition according to claim 1, characterized in that the monomer M2 comprising at least two (meth)acrylic functions per monomer is chosen from 1,3-butylene glycol dimethacrylate; 1,4-butanediol dimethacrylate; 1,6 hexanediol diacrylate; 1,6 hexanediol dimethacrylate; diethylene glycol dimethacrylate; dipropylene glycol diacrylate; ethoxylated (10) bisphenol a diacrylate; ethoxylated (2) bisphenol a dimethacrylate; ethoxylated (3) bisphenol a diacrylate; ethoxylated (3) bisphenol a dimethacrylate; ethoxylated (4) bisphenol a diacrylate; ethoxylated (4) bisphenol a dimethacrylate; ethoxylated bisphenol a dimethacrylate; ethoxylated (10) bisphenol dimethacrylate; ethylene glycol dimethacrylate; polyethylene glycol (200) diacrylate; polyethylene glycol (400) diacrylate; polyethylene glycol (400) dimethacrylate; polyethylene glycol (400) dimethacrylate; polyethylene glycol (600) diacrylate; polyethylene glycol (600) dimethacrylate; polyethylene glycol 400 diacrylate; propoxylated (2) neopentyl glycol diacrylate; tetraethylene glycol diacrylate; tetraethylene glycol dimethacrylate; tricyclodecane dimethanol diacrylate; tricyclodecanedimethanol dimethacrylate; triethylene glycol diacrylate; triethylene glycol dimethacrylate; tripropylene glycol diacrylate; ethoxylated (15) trimethylolpropane triacrylate; ethoxylated (3) trimethylolpropane triacrylate; ethoxylated (6) trimethylolpropane triacrylate; ethoxylated (9) trimethylolpropane triacrylate; ethoxylated 5 pentaerythritol triacrylate; ethoxylated (20) trimethylolpropane triacrylate; propoxylated (3) glyceryl triacrylate; trimethylolpropane triacrylate; propoxylated (5.5) glyceryl triacrylate; pentaerythritol triacrylate; propoxylated (3) glyceryl triacrylate; propoxylated (3) trimethylolpropane triacrylate; trimethylolpropane triacrylate; trimethylolpropane trimethacrylate; tris(2-hydroxy ethyl) isocyanurate triacrylate; di-trimethylolpropane tetraacrylate; dipentaerythritol pentaacrylate; ethoxylated (4) pentaerythritol tetraacrylate; pentaerythritol tetraacrylate; dipentaerythritol hexaacrylate; 1,10 decanediol diacrylate; 1,3-butylene glycol diacrylate; 1,4-butanediol diacrylate; 1,9-nonanediol diacrylate; 2-(2-Vinyloxyethoxy)ethyl acrylate; 2-butyl-2-ethyl-1,3-propanediol diacrylate; 2-methyl-1,3-propanediol diacrylate; 2-methyl-1,3-propanediyl ethoxy acrylate; 3 methyl 1,5-pentanediol diacrylate; alkoxylated cyclohexane dimethanol diacrylate; alkoxylated hexanediol diacrylate; cyclohexane dimethanol diacrylate; ethoxylated cyclohexane dimethanol diacrylate; diethyleneglycol diacrylate; dioxane glycol diacrylate; ethoxylated dipentaerythritol hexaacrylate; ethoxylated glycerol triacrylate; ethoxylated neopentyl glycol diacrylate; hydroxypivalyl hydroxypivalate diacrylate; neopentyl glycol diacrylate; poly (tetramethylene glycol) diacrylate; polypropylene glycol 400 diacrylate; polypropylene glycol 700 diacrylate; propoxylated (6) ethoxylated bisphenol A diacrylate; propoxylated ethylene glycol diacrylate; propoxylated (5) pentaerythritol tetraacrylate; and propoxylated trimethylol propane triacrylate; or mixtures thereof.

9. The composition according to claim 1, characterized in that the (meth)acrylic composition MC1 comprises from 0.5 parts by weight to 10 parts by weight of a block copolymer BC1.

10. The composition according to claim 1, characterized in that the (meth)acrylic composition MC1 comprises from 0.5 parts by weight to 7 parts by weight of a block copolymer BC1.

11. A process for preparing the (meth)acrylic composition MC1, according to claim 1, said process is comprising the following steps:
i) providing the following components:
(a) 100 parts by weight of a liquid (meth)acrylic syrup comprising:
(a1) from 1% by weight to 50% by weight of one or more (meth)acrylic polymers P1, and
(a2) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) optionally from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer, and
(e) optionally from 0.01 part by weight to 5 parts by weight of a polymerization initiator, and
ii) mixing the components a), b) and d) or a) to d) or a) to e)

12. The process according to claim 11, characterized in that it further comprises (c) from 20 parts by weight to 300 parts by weight of a mineral filler C.

13. The process according to claim 10, characterized in that it further comprises
(e) from 0.01 part by weight to 5 parts by weight of a polymerization initiator.

14. Use of a (meth)acrylic composition MC1 according to claim 1 to prepare a polymeric composite material.

15. Use of a (meth)acrylic composition MC1 according to claim 1 to impregnate a fibrous substrate.

16. Use of a (meth)acrylic composition MC1 according to claim 1 to reduce the cycle time for preparing a polymeric composite material.

17. A composite material obtained by polymerization of a (meth)acrylic composition MC1 as claimed in claim 1.

18. A composite material obtained by polymerization of a (meth)acrylic composition MC1 as prepared according to the process according to claim 11.

19. The composite material according to claim 17, used as (meth)acrylic mineral composite.

20. A composite material comprising the (meth)acrylic composition MC1 as claimed in claim 1 after polymerization of said (meth)acrylic composition MC1.

21. The composite material according to claim 17, used composite for making bathroom and/or kitchen equipment, such as countertops, kitchen sinks, bathroom sinks, shower trays, baths tubes or fascia panels.

22. Use of the composite material according to claim 17, for the fabrication of bathroom and/or kitchen equipment, such as countertops, kitchen sinks, bathroom sinks, shower trays, baths tubes or fascia panels.

23. Use of the composite material according to claim 17 as bathroom and/or kitchen equipment, such as countertops, kitchen sinks, bathroom sinks, shower trays, baths tubes or fascia panels.

24. A process for manufacturing a composite material, said process comprising:
i) providing the following components
(a) 100 parts by weight of a liquid (meth)acrylic syrup comprising:
(a1) from 1% by weight to 50% by weight of one or more (meth)acrylic polymers P1, and
(a2) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer, and
(e) from 0.01 part by weight to 5 parts by weight of a polymerization initiator,
ii) mixing the components a) to e).
iii) polymerizing the (meth)acrylic composition MC1.

25. A process for reducing the cycle time for preparing a polymeric composite material from a (meth)acrylic composition MC1, said process comprising:
i) providing the following components
(a) 100 parts by weight of a liquid (meth)acrylic syrup comprising:
(a1) from 1% by weight to 50% by weight of one or more (meth)acrylic polymers P1, and
(a2) from 50% by weight to 99% by weight of one or more (meth)acrylic monomers M1, each monomer M1 comprising only one (meth)acrylic function per monomer,
(b) from 0.5 parts by weight to 15 parts by weight of a block copolymer BC1,
(c) from 20 parts by weight to 300 parts by weight of a mineral filler C,
(d) from 0.01 part by weight to 5 parts by weight of a (meth)acrylic monomer M2, the monomer M2 comprising at least two (meth)acrylic functions per monomer, and
(e) from 0.01 part by weight to 5 parts by weight of a polymerization initiator,
ii) mixing the components a) to e).
iii) polymerizing the (meth)acrylic composition MC1.
